(19) United States
(12) Patent Application Publication
(10) Pub. No.: US 2020/0114372 A1
(43) Pub. Date: Apr. 16, 2020

(54) PAINT SPRAY CAP GUARD

(71) Applicant: Joseph Francey, Harriston (CA)

(72) Inventor: Joseph Francey, Harriston (CA)

(21) Appl. No.: 16/162,299

(22) Filed: Oct. 16, 2018

(51) Int. Cl. B05B 1/28; B05B 12/36

(52) U.S. Cl. CPC B05B 1/28; B05B 15/16; B05B 12/36

(57) ABSTRACT

A spray-guard for a spray-can, the spray-can including a top-end having a spray-nozzle. The spray-guard includes a cap-ring, a cap-body, a cap-top, a first-pillar and a second-pillar. The cap-top is configured to pivot the cap-body into a paint-guard position. The paint-guard position includes the length of the cap-body located above the spray-nozzle to allow a user to spray straight lines.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of paint accessories and more specifically relates to a paint spray cap with integral spray guard.

### 2. Description of Related Art

Many construction projects require painting for good esthetics. A considerable amount of interior wall and ceiling painting is now accomplished by spray painting. This is particularly true in commercial settings where high volume justifies the additional spray-painting equipment expense.

It is difficult to create or frame a straight line around trim, windows, doors, edges and other adornments due to “over spray” which occurs after paint exits the nozzle of a spray gun. The use of masking tape and plastic or paper sheeting to form a protective film and straighter lines is somewhat effective, but it is also labor intensive. Furthermore, when masking tape is not removed properly, it leaves a residue that is quite sticky and difficult to clean. Thus, a suitable solution is desired.

U.S. Pat. No. 8,632,022 to Terry Potter relates to a spray guide. The described spray guide includes an arm having a first end and a second end. A mechanism is used for removably attaching the first end of the arm to the swivel angle head, so that the arm will extend over the swivel angle head and the spray nozzle. A wheel is also provided. Another mechanism is provided for rotatably connecting the wheel to the second end of the arm. When an edge of the wheel is placed in a corner joint between a wall and a ceiling and the spray want manually moved there along, the wheel will rotate in the corner joint to allow paint to be evenly sprayed from the spray nozzle onto an area of the wall adjacent to the ceiling. Also disclosed herein is a spray nozzle assembly for use with a handheld sprayer. Further, a spray guide designed for minimizing overspray is also disclosed herein.

### BRIEF SUMMARY OF THE INVENTION

In view of the foregoing disadvantages inherent in the known paint accessories art, the present disclosure provides a novel paint spray cap guard. The general purpose of the present disclosure, which will be described subsequently in greater detail, is to provide a cap on a spray can that can modify to become a guard for spraying straight lines.

A spray-guard is disclosed herein. The spray-guard includes a cap-ring which may be for attachment to the top-end of the spray-can. The cap-ring may include a first-circumference. A cap-body may be seated above the cap-ring. The cap-body may include a folded-configuration and an unfolded-configuration. The folded-configuration may include the cap-body may have a second-circumference and the unfolded-configuration may include the cap-body may have a first-end, a second-end, and a length therebetween.

The length may be substantially horizontal relative to the spray-can and the first-end and the second-end may be attached together when the cap-body may be in the folded-configuration.

Further, a cap-top may be at least partially attached to the cap-body and the cap-top may include a third-circumference. A first-pillar may be fixedly-attached to the cap-ring at a first distal-end and pivotally-attached to the cap-top at a first proximal-end. In addition, a second-pillar may be located parallel to the first-pillar, the second-pillar pivotally-attached to the cap at a second distal-end and fixedly attached to the cap-top at a second proximal-end.

A method of using the spray-guard is also disclosed herein. The method of using the spray-guard may comprise the steps of: providing the spray-guard as above; separating the first-end and the second-end of the cap-body; unfolding the cap-body into the unfolded-configuration; pivoting the cap-body into the paint-guard position via the cap-top; and spraying via the spray-nozzle.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a paint spray cap guard, constructed and operative according to the teachings of the present disclosure.

FIG. 1 is a bottom-side perspective view of the spray-guard during an ‘in-use’ condition, according to an embodiment of the disclosure.

FIG. 2A is a top-side perspective view of the spray-guard of FIG. 1, according to an embodiment of the present disclosure.

FIG. 2B is a top perspective view of the spray-guard of FIG. 1, according to an embodiment of the present disclosure.

FIG. 3 is a rear perspective view of the spray-guard of FIG. 1, according to an embodiment of the present disclosure.

FIG. 4 is a bottom-side perspective view of the spray-guard of FIG. 1, according to an embodiment of the present disclosure.

FIG. 5 is a flow diagram illustrating a method of use for spray-guard, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to paint accessories and more particularly to a paint spray cap guard as used to improve painting procedures using the paint spray cap with integral spray guard.

Generally, disclosed is a device including a lightweight easily-portable barrier which may be entirely self-contained. The device may include a cap on a spray can that can modify to become a guard for spraying straight lines. The cap may unfold to become a shield in order to concentrate paint spray in a line that may be used against an edge so that paint won't overlap. During the spraying, the cap may still be attached to a body of the spray can but allowing operation of a spray nozzle. When the spray nozzle is activated the barrier may prevent the paint spray from deploying outside a direct area. The spray can then can easily be used to create straight lines on any surface by directing the flow of the spray and limiting it from to wide an area. In one embodiment, the cap may unfold to provide the shield. In one example of this embodiment, the unfolded cap may make up the whole shield, or may make up a piece of the shield. In another embodiment, the shield may be attached to a section of the cap and be removed from the cap to be assembled into the shield.

The device may include a bottom ring that clips onto the spray can, which does not move. Slightly above the bottom ring may include perforated plastic which may break off, allowing the top of the cap to do a 180-degree flip. The guard may include two wings either side. Two pillars may be located (one on either side of the spray) and may remain in place so that the top of the cap is able to 180-degree flip and be fully assembled. In between the two pillars may also be perforated so that it can separate into two board like pieces that may mount into hooks that are on an outside of the cap. The two pillars may keep the barrier flat. In addition to this, an underside of the paint guard may include ribs to catch the paint spray.

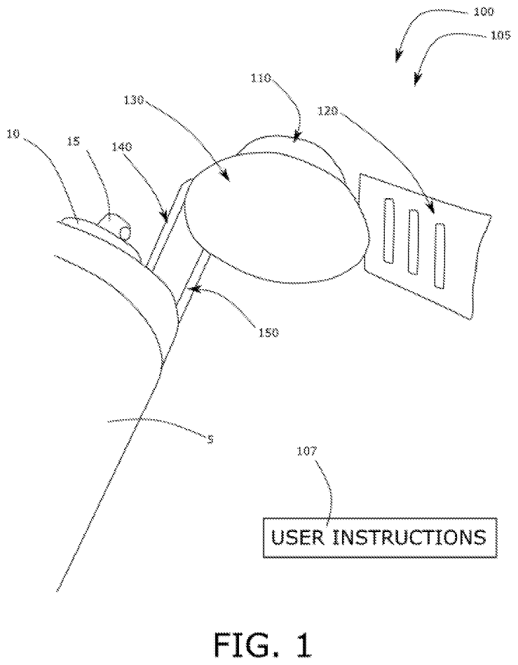

Referring now more specifically to the drawings by numerals of reference, there is shown in FIGS. 1-4, various views of a spray-guard 100.

FIG. 1 shows a spray-guard 100 according to an embodiment of the present disclosure. As Illustrated, the spray-guard 100 may include a cap-ring 110, a cap-body 120, a cap-top 130, a first-pillar 140 and a second-pillar 150. As show, the spray-guard 100 may be used for a spray-can 5. The spray-can 5 may include a top-end 10 having a spray-nozzle 15.

According to one embodiment, the spray-guard 100 may be arranged as a kit 105. The kit 105 may include set of user instructions 107. The instructions 107 may detail functional relationships in relation to the structure of the spray-guard 100 (such that the spray-guard 100 can be used, maintained, or the like, in a preferred manner).

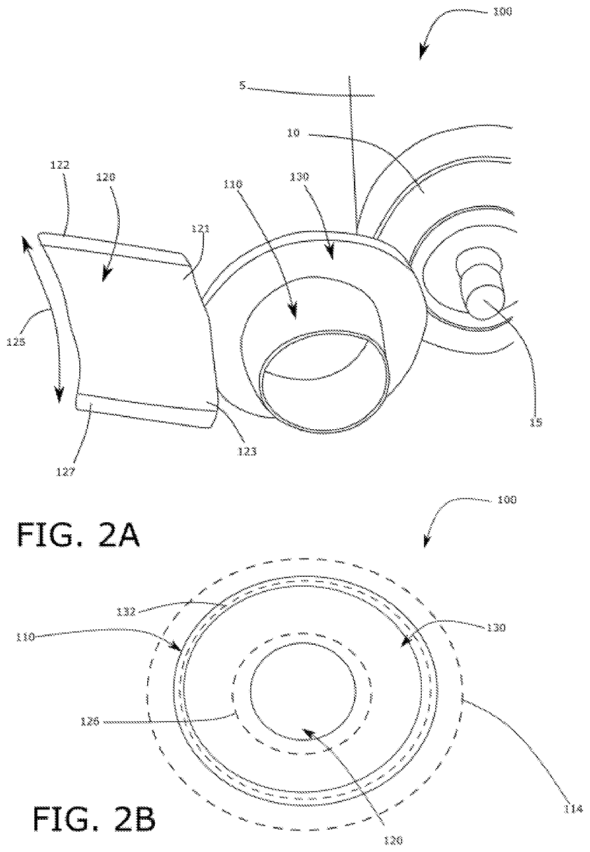

FIGS. 2A-2B show top-side/top perspective views of the spray-guard 100 of FIG. 1, according to an embodiment of the present disclosure. As shown, the cap-ring 110 may be for attachment to the top-end 10 of the spray-can 5. The cap-ring 110 may include a first-circumference 114. Preferably, the cap-ring 110 may be made from a rigid material configured to securely clip on to the top-end 10 of the spray-can 5. In one embodiment, the cap-ring 110 may be constructed from plastic.

Further, the cap-body 120 may be seated above the cap-ring 110. The cap-body 120 may include a folded-configuration and an unfolded-configuration. The folded-configuration may include the cap-body 120 having a second-circumference 126; the unfolded-configuration may include the cap-body 120 having a first-end 121, a second-end 123, and a length 125 therebetween, the length 125 being substantially horizontal relative to the spray-can 5. In one embodiment, the first-end 121 and the second-end 123 may be attached together when the cap-body 120 is in the folded-configuration.

As shown, the first-end 121 of the cap-body 120 may include a first-wing 122 having a first upward-flap 124 to aid in keeping the length 125 of the cap-body 120 straight when in the unfolded-configuration. Similarly, the second-end 123 of the cap-body 120 may include a second-wing 127 having a second upward-flap 128 to further aid in keeping the length 125 of the cap-body 120 straight when in the unfolded-configuration. In one embodiment, the cap-ring 110 may include a first-hook 116 configured to receive and hold the first-wing 122. Likewise, the cap-ring 110 may further include a second-hook 118 located parallel to the first-hook 116, and wherein the second-hook 118 is configured to receive and hold the second-wing 127.

The cap-top 130 may be at least partially attached to the cap-body 120. The cap-top 130 may include a third-circumference 132. As shown in FIG. 2B, the first-circumference 114, the second-circumference 126 and the third-circumference 132 may be concentric when the cap-body 120 is in the folded-configuration.

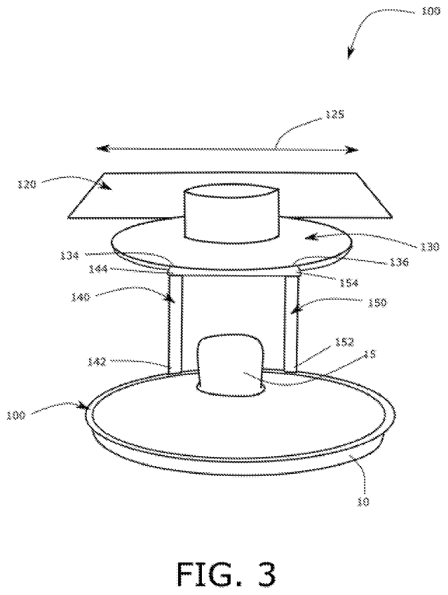

FIG. 3 shows a rear perspective view of the spray-guard 100 of FIG. 1, according to an embodiment of the present disclosure. The first-pillar 140 may be fixedly-attached to the cap-ring 110 at a first distal-end 142 and pivotally-attached to the cap-top 130 at a first proximal-end 144. Similarly, the second-pillar 150 may be located parallel to the first-pillar 140 and pivotally-attached to the cap-ring 110 at a second distal-end 152 and fixedly attached to the cap-top 130 at a second proximal-end 154. The first-pillar 140 and the second-pillar 150 may be constructed from a rigid material, similar, if not the same to the material of the cap-ring 110. For example, in one embodiment, first pillar and the second pillar may be constructed from plastic.

Preferably, the cap-top 130 may be pivotally-attached to the first-pillar 140 and the second-pillar 150 via a first-hinge 134 and a second-hinge 136, respectively. In one embodiment, the first-hinge 134 and the second-hinge 136 may be integrated into a rectangular hinge-piece, as demonstrated in this figure. However, in other embodiments, the first-hinge 134 and the second-hinge 136 may be separate of each other. Further, the cap-top 130 may be configured to pivot at least 180 degrees. The cap-top 130 may attached at a mid-section of the length 125 when the cap-body 120 is in the unfolded-configuration. Further, the cap-top 130 may be configured to pivot via the first-pillar 140 and the second-pillar 150 when the cap-body 120 is in the unfolded-configuration. Preferably, the cap-top 130 may be configured to pivot the cap-body 120 in the unfolded-configuration into a paint-guard position. The paint-guard position may include the length 125 of the cap-body 120 located above the spray-nozzle 15 to allow a user to spray straight lines. Further, the cap-body 120 may be constructed from a flexible-material configured to allow easy manipulation of the cap-body 120 from the folded-configuration to the unfolded-configuration and vice versa. In one embodiment, the flexible-material may comprise plastic.

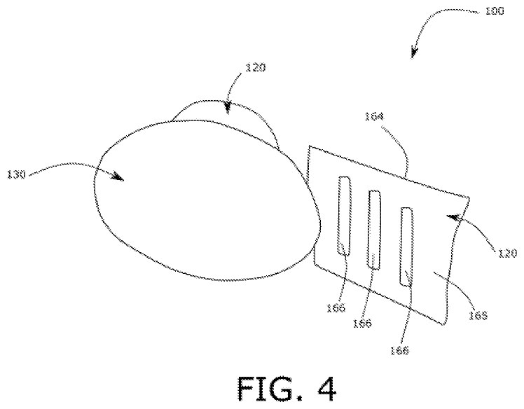

FIG. 4 shows a bottom-side perspective view of the spray-guard 100 of FIG. 1, according to an embodiment of the present disclosure. The cap-body 120 may include an inner-surface 164 and an outer-surface 165 relative to the folded-configuration. As shown, the inner-surface 164 may be upward-facing and the outer-surface 165 may be downward-facing when the cap-body 120 is in the spray-guard position. Preferably, the outer-surface 165 may include paint-catching means 166 configured to prevent paint drips when the user is spraying the straight lines. The paint-catching means 166 may be raised strips spaced along the length 125 of the cap-body 120 so as to catch paint. In one embodiment, the paint-catching means 166 may be constructed from plastic.

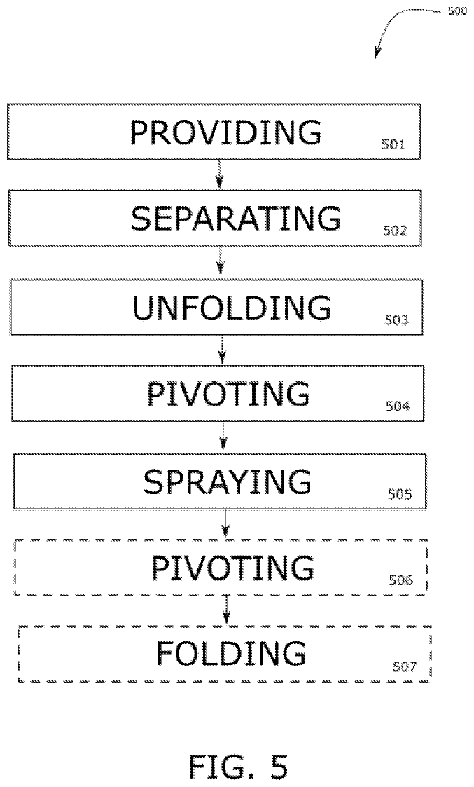

FIG. 5 is a flow diagram 550 illustrating a method of using a spray-guard for a spray-can 500, according to an embodiment of the present disclosure. As illustrated, the method of using a spray-guard for a spray-can 500 may include the steps of: providing 501 the spray-guard 100 as above; separating 502 the first-end 121 and the second-end 123 of the cap-body 120; unfolding 503 the cap-body 120 into the unfolded-configuration; pivoting 504 the cap-body 120 into the paint-guard position via the cap-top 130; and spraying 505 the spray-nozzle 15. Further steps may include: pivoting 506 the cap-body 120 out of the paint-guard position; and folding 507 the cap-body 120 into the folded-configuration.

It should be noted that step 506 and step 507 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for spray-guard 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A spray-guard for a spray-can, the spray-can including a top-end having a spray-nozzle, the spray-guard comprising:
a cap-ring for attachment to the top-end of the spray-can, the cap-ring including a first-circumference;
a cap-body seated above the cap-ring, the cap-body including a folded-configuration and an unfolded-configuration, the folded-configuration including the cap-body having a second-circumference, the unfolded-configuration including the cap-body having a first-end, a second-end, and a length therebetween, the length being substantially horizontal relative to the spray-can, and wherein the first-end and the second-end are attached together when the cap-body is in the folded-configuration;
a cap-top at least partially attached to the cap-body, the cap-top including a third-circumference;
a first-pillar fixedly-attached to the cap-ring at a first distal-end and pivotally-attached to the cap-top at a first proximal-end;
a second-pillar located parallel to the first-pillar, the second-pillar pivotally-attached to the cap at a second distal-end and fixedly attached to the cap-top at a second proximal-end;
wherein the cap-top is attached at a mid-section of the length when the cap-body is in the unfolded-configuration;
wherein the cap-top is configured to pivot via the first-pillar and the second-pillar when the cap-body is in the unfolded-configuration; and
wherein the cap-top is configured to pivot the cap-body in the unfolded-configuration into a paint-guard position, and wherein the paint-guard position includes the length of the cap-body located above the spray-nozzle to allow a user to spray straight lines

2. The spray-guard of claim 1, wherein the cap-top is configured to pivot at least 180 degrees.

3. The spray-guard of claim 2, wherein the cap-top is pivotally-attached to the first-pillar and the second-pillar via a first-hinge and a second-hinge, respectively.

4. The spray-guard of claim 1, wherein the first-end of the cap-body includes a first-wing having a first upward-flap to aid in keeping the length of the cap-body straight when in the unfolded-configuration.

5. The spray-guard of claim 1, wherein the second-end of the cap-body includes a second-wing having a second upward-flap to further aid in keeping the length of the cap-body straight when in the unfolded-configuration.

6. The spray-guard of claim 1, wherein the cap-ring includes a first-hook configured to receive and hold the first-wing.

7. The spray-guard of claim 6, wherein the cap-ring further includes a second-hook located parallel to the first-hook, and wherein the second-hook is configured to receive and hold the second-wing.

8. The spray-guard of claim 1, wherein the cap-body includes an inner-surface and an outer-surface relative to the folded-configuration.

9. The spray-guard of claim 8, wherein the inner-surface is upward-facing and the outer-surface is downward-facing when the cap-body is in the spray-guard position.

10. The spray-guard of claim 8, wherein the outer-surface includes paint-catching means configured to prevent paint drips when the user is spraying the straight lines.

11. The spray-guard of claim 10, wherein the paint-catching means are raised strips.

12. The spray-guard of claim 11, wherein the raised strips are constructed from plastic.

13. The spray-guard of claim 1, wherein the cap-ring is constructed from plastic.

14. The spray-guard of claim 1, wherein the first pillar and the second pillar are constructed from plastic.

15. The spray-guard of claim 1, wherein the cap-body is constructed from a flexible-material configured to allow easy manipulation of the cap-body from the folded-configuration to the unfolded-configuration and vice versa.

16. The spray-guard of claim 15, wherein the flexible-material comprises plastic.

17. A spray-guard for a spray-can, the spray-can including a top-end having a spray-nozzle, the spray-guard comprising:
a cap-ring for attachment to the top-end of the spray-can, the cap-ring including a first-circumference;
a cap-body seated above the cap-ring, the cap-body including a folded-configuration and an unfolded-configuration, the folded-configuration including the cap-body having a second-circumference, the unfolded-configuration including the cap-body having a first-end, a second-end, and a length therebetween, the length being substantially horizontal relative to the spray-can, and wherein the first-end and the second-end are attached together when the cap-body is in the folded-configuration;
a cap-top at least partially attached to the cap-body, the cap-top including a third-circumference;
a first-pillar fixedly-attached to the cap-ring at a first distal-end and pivotally-attached to the cap-top at a first proximal-end;
a second-pillar located parallel to the first-pillar, the second-pillar pivotally-attached to the cap at a second distal-end and fixedly attached to the cap-top at a second proximal-end;
wherein the cap-top is attached at a mid-section of the length when the cap-body is in the unfolded-configuration;
wherein the cap-top is configured to pivot via the first-pillar and the second-pillar when the cap-body is in the unfolded-configuration; and
wherein the cap-top is configured to pivot the cap-body in the unfolded-configuration into a paint-guard position, and wherein the paint-guard position includes the length of the cap-body located above the spray-nozzle to allow a user to spray straight lines;
wherein the cap-top is configured to pivot at least 180 degrees;
wherein the cap-top is pivotally-attached to the first-pillar and the second-pillar via a first-hinge and a second-hinge, respectively;
wherein the first-end of the cap-body includes a first-wing having a first upward-flap to aid in keeping the length of the cap-body straight when in the unfolded-configuration;
wherein the second-end of the cap-body includes a second-wing having a second upward-flap to further aid in keeping the length of the cap-body straight when in the unfolded-configuration;
wherein the cap-ring includes a first-hook configured to receive and hold the first-wing;
wherein the cap-ring further includes a second-hook located parallel to the first-hook, and wherein the second-hook is configured to receive and hold the second-wing;
wherein the cap-body includes an inner-surface and an outer-surface relative to the folded-configuration;
wherein the inner-surface is upward-facing and the outer-surface is downward-facing when the cap-body is in the spray-guard position;
wherein the outer-surface includes paint-catching means configured to prevent paint drips when the user is spraying the straight lines;
wherein the paint-catching means are raised strips;
wherein the raised strips are constructed from plastic;
wherein the cap-ring is constructed from the plastic;
wherein the first pillar and the second pillar are constructed from the plastic;
wherein the cap-body is constructed from a flexible-material configured to allow easy manipulation of the cap-body from the folded-configuration to the unfolded-configuration and vice versa; and
wherein the flexible-material comprises the plastic.

18. The spray-guard of claim 17, further comprising set of instructions; and
wherein the spray-guard is arranged as a kit.

19. A method of using a spray-guard for a spray-can, the spray-can including a top-end having a spray-nozzle, the method comprising the steps of:
Providing the spray-guard for the spray-can, the spray-guard having:
a cap-ring for attachment to the top-end of the spray-can, the cap-ring including a first-circumference;
a cap-body seated above the cap-ring, the cap-body including a folded-configuration and an unfolded-configuration, the folded-configuration including the cap-body having a second-circumference, the unfolded-configuration including the cap-body having a first-end, a second-end, and a length therebetween, the length being substantially horizontal relative to the spray-can, and wherein the first-end and the second-end are attached together when the cap-body is in the folded-configuration;
a cap-top at least partially attached to the cap-body, the cap-top including a third-circumference;
a first-pillar fixedly-attached to the cap-ring at a first distal-end and pivotally-attached to the cap-top at a first proximal-end;
a second-pillar located parallel to the first-pillar, the second-pillar pivotally-attached to the cap at a second distal-end and fixedly attached to the cap-top at a second proximal-end;
wherein the cap-top is attached at a mid-section of the length when the cap-body is in the unfolded-configuration;
wherein the cap-top is configured to pivot via the first-pillar and the second-pillar when the cap-body is in the unfolded-configuration; and
wherein the cap-top is configured to pivot the cap-body in the unfolded-configuration into a paint-guard position, and wherein the paint-guard position includes the length of the cap-body located above the spray-nozzle to allow a user to spray straight lines;
separating the first-end and the second-end of the cap-body;
unfolding the cap-body into the unfolded-configuration;
pivoting the cap-body into the paint-guard position via the cap-top; and
spraying the spray-nozzle.

20. The method of claim 19, further comprising the steps of:
pivoting the cap-body out of the paint-guard position; and
folding the cap-body into the folded-configuration.
